(19) United States
(12) Patent Application Publication
(10) Pub. No.: US 2014/0072766 A1
(43) Pub. Date: Mar. 13, 2014

(54) APPARATUS AND METHODS FOR CREATING A WOOD GRAIN APPEARANCE ON SHEET MATERIAL

(71) Applicant: BFCOS, Inc., Fort Wayne, IN (US)

(72) Inventor: Robert M. Bennington, Sharpsville, PA (US)

(21) Appl. No.: 14/021,091

(22) Filed: Sep. 9, 2013

Related U.S. Application Data
(60) Provisional application No. 61/698,900, filed on Sep. 10, 2012.

(51) Int. Cl. B44F 9/02

(52) U.S. Cl. CPC B44F 9/02
USPC 428/151; 101/3.1; 101/32

(57) ABSTRACT

A depth-changing pattern for simulating a wood grain appearance is debossed on strip material, such as a metal or steel sheet, by longitudinally feeding the strip material past a debossing drum having upraised protrusions with transversely-varying depths that impact the surface of the strip material, forming depressions in the surface as the sheet is pulled past the debossing drum. As the sheet material is pulled through the debossing drum assembly, it is moved in a direction parallel with the rotational axis of the debossing drum and transverse to the direction of material feed, thereby creating a random or non-repeating and depth-changing pattern. The strip material may then be subjected to further processing steps such as forming, coloring and staining to produce an article having a realistic wood grain appearance.

### CROSS-REFERENCE TO RELATED APPLICATION

This application claims the benefit of U.S. Provisional Patent Application Ser. No. 61/698,900 filed Sep. 10, 2012, which is incorporated herein by reference.

### FIELD OF THE INVENTION

The present invention relates to simulated wood appearances on items and products, and more particularly relates to debossing apparatus and methods for creating depth-changing, non-repeating patterns that simulate a wood grain appearance on a sheet material surface such as steel or other metals.

### BACKGROUND INFORMATION

In various applications and uses ranging from park bench equipment, restaurant chairs, and premium healthcare seating, a preferred material is tubular or sheet metal steel. The use of metal or steel provides durability and maintenance-free use. However, there is a desire to soften the cold, formal qualities of metal and steel objects by enhancing or altering the external appearance of the particular item or object. For example, it may be desirable to have the appearance or texture of wood on the exposed surfaces. To further enhance the aesthetic appeal with a visually decorative and pleasing effect, it would be desirable to stain the simulated wood appearance with a wood-like stain such as cherry, walnut or rosewood.

Various techniques and processes have been developed for simulating a wood grain appearance on metal and steel items and objects that are used in both private and public settings and environments. For example, one technique is to laminate the metal or steel object with a vinyl film having a wood grain pattern printed thereon. Another process involves directly printing the wood grain pattern on the surface of the metal that is then formed into an object such as a restaurant bench or furniture item. However, such printed surfaces are susceptible to being marred by scratch and scuff marks and their restoration is difficult and expensive. Another technique is to manually stain the steel, metal strip or sheet in order to give it the striated appearance of wood grain, but this technique requires considerable artistic skill and is also quite expensive.

Drums have been used to produce wood grain patterns in metal sheets. However, the patterns created by such drums have uniform depths that do not provide an optimal wood grain appearance when the surface is colored and stained. Such drums have been used in combination with opposing drums that are aligned with each other at uniform separation distances. However, it has been found that such an arrangement does not provide a realistic wood grain appearance because the pattern repeats itself upon each revolution of the drum rather than providing a more natural-looking non-repeating pattern.

### SUMMARY OF THE INVENTION

The present invention provides apparatus and methods utilizing a debossing drum for creating a wood grain appearance on strip materials such as a metal or steel sheet. The wood grain appearance comprises a depth-changing pattern, and may be non-repeating as a result of movement of the strip material transversely across the debossing drum as the strip material is fed in a length-wise direction. As more fully described below, rather than repeating the identical wood grain pattern upon each rotation of the debossing drum, the transverse movement of the work piece results in non-repeating wood grain patterns. The debossing drum has an outer surface covered with upraised protrusions or markings in the form of a pattern such as wood grain that is arranged in a depth-changing manner. In accordance with embodiments of the present invention, the upraised protrusions or markings on the drum or roller may vary in depth transversely from the center of the drum outwards. The depth variation may enhance the markings on certain areas such as the cathedral portion of a wood grain pattern, while minimizing the depth and relevance of the ticking of the wood grain pattern. The strip material or work piece may move back and forth in relation to the debossing drum, transverse to the linear feed of the strip material, in order to create a non-repeating pattern on the strip material through contact of the drum outer surface against the surface of the strip material.

After the strip material is fed through the debossing drum, a series of steps or processes may then follow to complete the process of creating a wood grain appearance on the strip material. In certain embodiments, the patterned strip material may be formed into a round tube shape by rolling and then welding the seam. The formed tube may be used as round tubing, or may be further formed by, e.g., sending it through a head reshaping tool to produce square, triangular, rectangular, D-shaped or other desired cross-sectional forms. The various cross-sections may then be cut to length and welded to complete the fabrication of the desired work piece, such as a chair of a desired configuration or any other item that uses wood as its main construction medium. The debossed material with its wood grain pattern may be cut into two dimensional shapes to later be fabricated into various three dimensional finished products.

In certain embodiments, after fabrication is complete, the work piece may be washed, e.g., in a bath of an alkaline solution, rinsed, washed in another bath, e.g., iron phosphate, and then dried in a heater to prepare the work piece for resin powder coating. Colored resin powder may then be electrostatically applied to the fabricated assemblies. The assemblies may then be heated to cure the resin and to bake the powder onto the assemblies. Thin milled resin powder may be used so that the debossing is not filled by the resin coating. The thin milled powder may determine the final color of the product. Stain, such as an oil-based stain, may be applied to the product, and then wiped off before it dries. The stain that remains in the depressed debossed areas contrasts with the base coat color creating a wood grain appearance. Due to the depth differences that are present in the pattern transversely across the metal sheets, the stain that settles into the debossed areas will vary in contrast, with deeper depressions having darker appearances. Essentially no artistic skills are required during the staining process to provide a realistic wood grain appearance to the metal surface.

An aspect of the present invention is to provide an apparatus for making a wood grain appearance on sheet material comprising a debossing assembly for imparting a non-repeating wood grain pattern on the sheet material, wherein the debossing assembly comprises a debossing drum and an opposing drum, and at least one of the debossing drum and opposing drum are supported by at least one height-adjustable piston that moves the debossing and opposing drums toward or away from each other to a position in which opposing surfaces of the debossing and opposing drum are unequally spaced from each other on one longitudinal end of the debossing and opposing drums in comparison with another longitudinal end of the debossing and opposing drums.

Another aspect of the present invention is to provide an apparatus for making a wood grain appearance on sheet material comprising a debossing drum for imparting a depth-changing wood grain pattern on the sheet material, wherein the debossing drum comprises protrusions extending from a generally cylindrical surface of the debossing drum, and the protrusions have different depths in different regions along the transverse length of the debossing drum.

A further aspect of the present invention is to provide a method of making a wood grain appearance on sheet material comprising feeding the sheet material through a debossing assembly to thereby impart a non-repeating wood grain pattern on the sheet material, wherein the debossing assembly moves the sheet material in a transverse direction as the sheet material is fed through the debossing assembly.

Another aspect of the present invention is to provide a method of making a wood grain appearance on sheet material comprising contacting the sheet material with a debossing drum to thereby impart a depth-changing wood grain pattern on the sheet material, wherein the debossing drum comprises protrusions extending from a generally cylindrical surface of the debossing drum, and the protrusions have different depths in different regions along the transverse length of the debossing drum.

A further aspect of the present invention is to provide a debossed sheet material comprising a non-repeating and depth-changing wood grain pattern.

These and other aspects of the present invention will be more apparent from the following description.

### BRIEF DESCRIPTION OF THE DRAWINGS

FIG. 1 is a partially schematic side view of a system for creating a wood grain appearance on sheet material in accordance with an embodiment of the present invention.

FIG. 2 is a top view of the system of FIG. 1.

FIG. 3 is an isometric view of a wood grain debossing unit in accordance with an embodiment of the present invention.

FIG. 4 is a side view of the debossing unit of FIG. 3.

FIG. 5 is a top view of the debossing unit of FIG. 3.

FIG. 6 is a front end view of the debossing unit of FIG. 3.

FIG. 7 illustrates a wood grain pattern on the surface of a debossing drum that is used to impart a three-dimensional wood grain pattern of sheet material in accordance with an embodiment of the present invention.

FIG. 8 illustrates the surface of a debossing drum including projections forming a wood grain pattern in which the projections have varying depths at different locations on the surface of the debossing drum. In the embodiment shown, the vertical direction in FIG. 8 corresponds to different transverse positions along the drum in a direction parallel with the rotational axis of the drum, while the horizontal direction in FIG. 8 corresponds to the circumferential direction around the drum.

FIG. 9 is a perspective view illustrating a formed and welded round tube having a wood grain surface in accordance with an embodiment of the present invention.

FIG. 10 illustrates cross-sectional end views of various tube shapes that may be formed in accordance with embodiments of the present invention.

FIG. 11 illustrates various seat designs having wood grain components fabricated in accordance with embodiments of the invention.

FIG. 12 illustrates a base powder coat being applied electrostatically to a chair having wood grain components fabricated in accordance with an embodiment of the present invention.

FIG. 13 illustrates the application of a stain coat to a chair having wood grain components fabricated in accordance with an embodiment of the present invention.

FIG. 14 schematically illustrates steps involved in the creation of a wood grain appearance on sheet material in accordance with an embodiment of the present invention.

FIG. 15 schematically illustrates steps involved in the creation of a wood grain appearance on a sheet material that is then formed into a tube in accordance with an embodiment of the present invention.

FIG. 16 schematically illustrates steps involved in the creation of a wood grain appearance on sheet material in accordance with an embodiment of the present invention.

### DETAILED DESCRIPTION

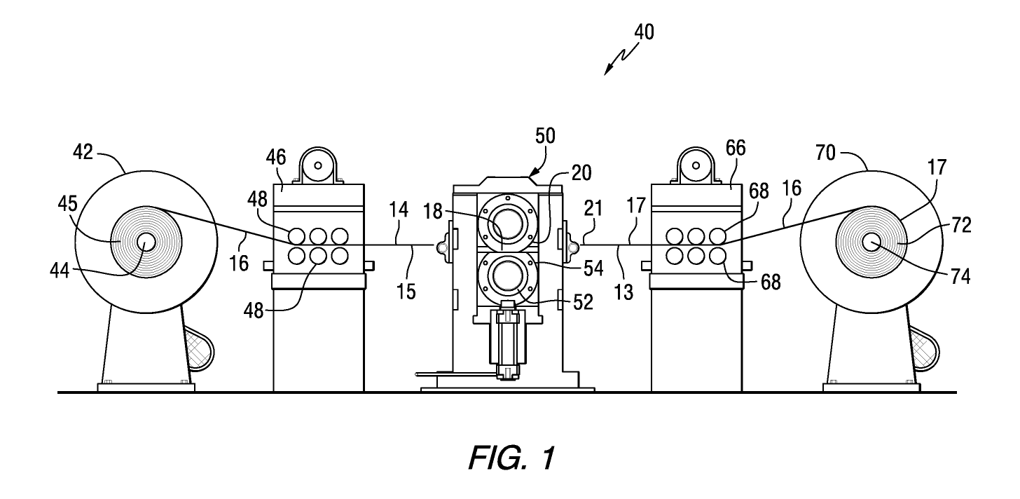

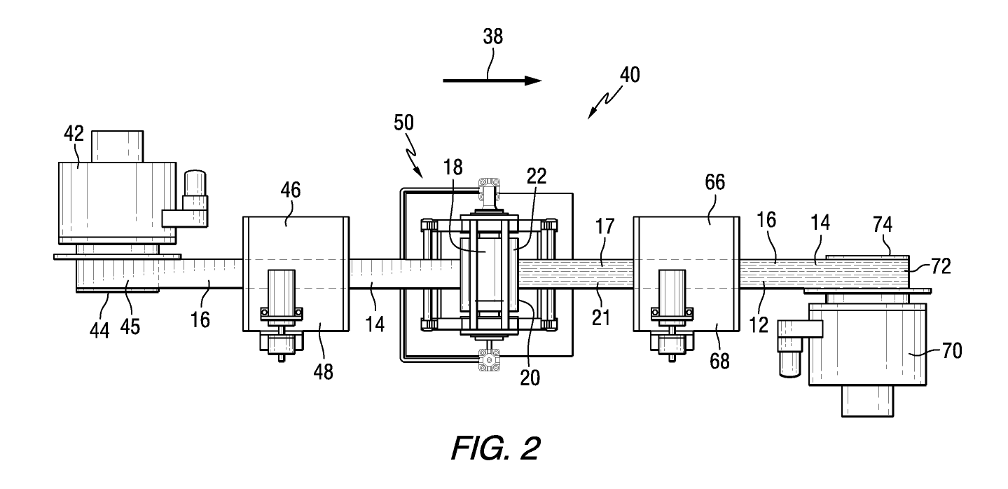

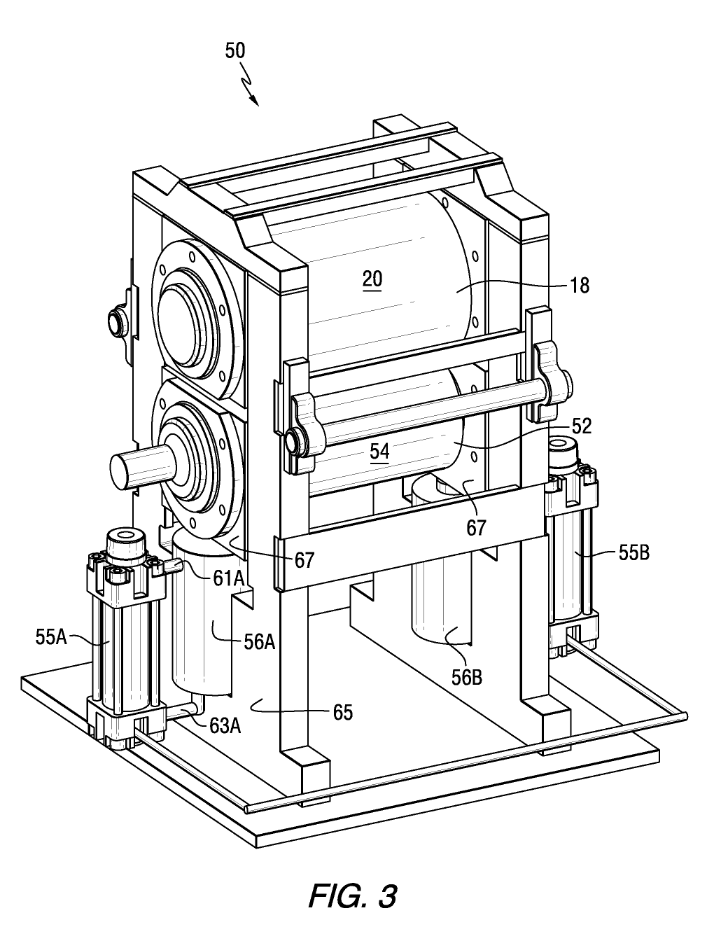

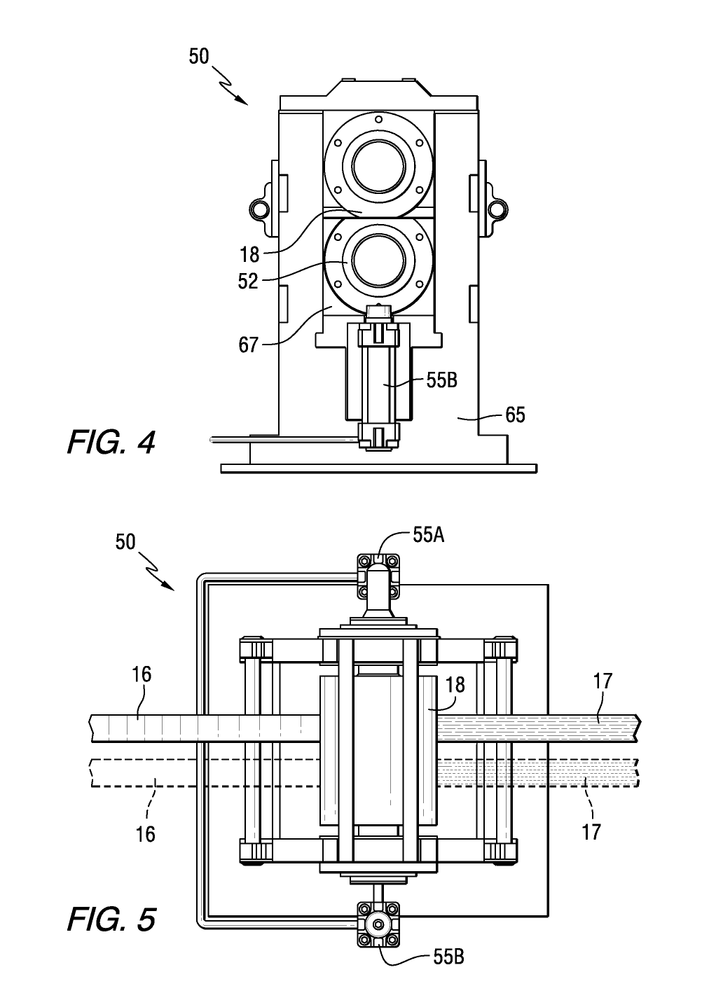

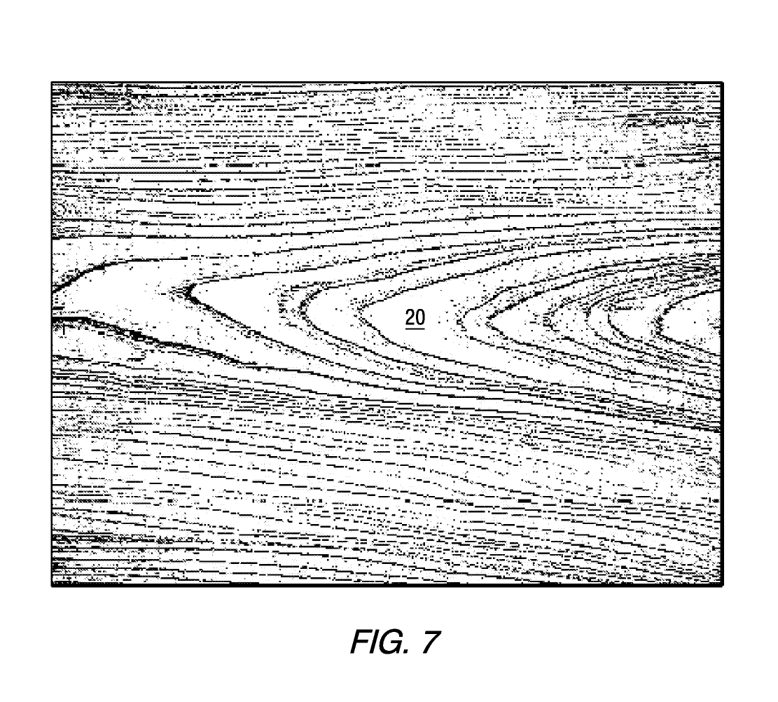

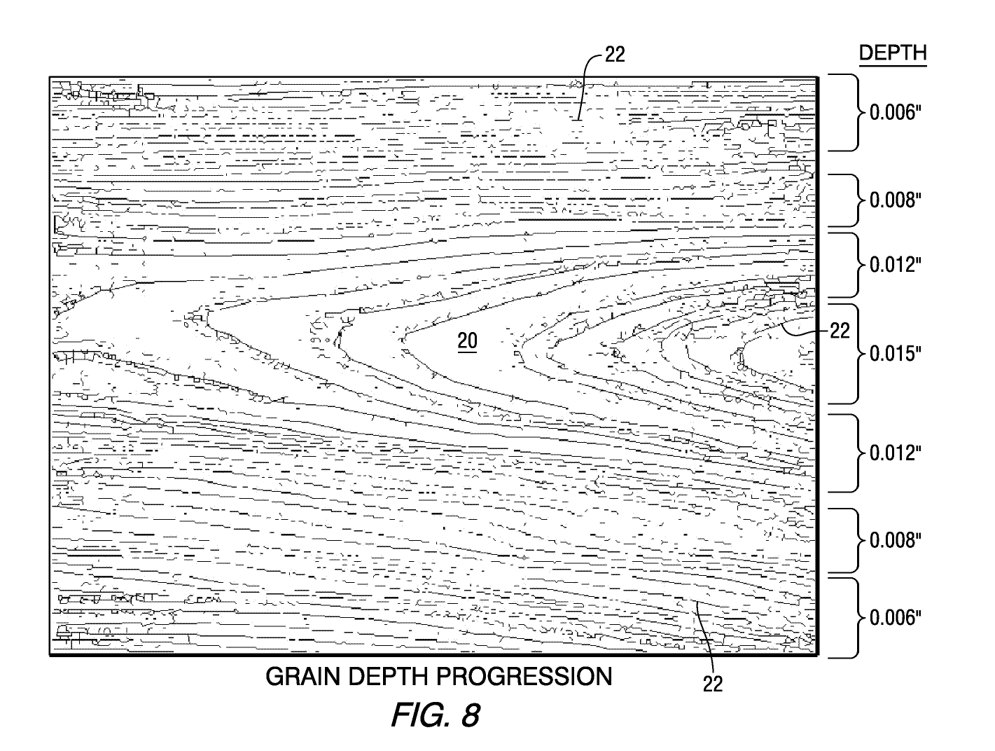

FIGS. 1 and 2 illustrate a system 40 for creating a wood grain appearance on sheet material in accordance with an embodiment of the present invention. FIGS. 3-6 illustrate a debossing assembly 50 that is part of the debossing system 40 in accordance with an embodiment of the present invention. FIGS. 7 and 8 illustrate an example of a wood grain debossing surface on the exterior of a debossing drum in accordance with an embodiment of the invention.

As shown in FIGS. 1 and 2, a debossing drum 18 or roller, also known as a debosser, has a circumferential external surface 20 that is used to deboss or impress a depth-changing wood grain pattern 12 on sheet material 16. The debossing drum 18 may have any suitable dimensions, for example, the drum 18 may be 40 inches wide, measured in a direction parallel with the rotational axis of the drum, and have a circumference of 36 inches. The sheet material 16 has a width that is less than the width of the drum 18. For example, the width of the sheet material 16 may be less than 80 percent of the width of the debossing drum 18, typically from 2 percent to 50 percent of the width of the drum 18, or from 5 percent to 25 percent of the width of the drum 18. The width of the sheet material typically ranges from 0.5 inch to 4 feet or more, for example, from 1 to 12 inches.

A wood grain pattern is arranged on the external surface 20 of the debossing drum 18 comprising upraised or projecting protrusions, ridges or bumps 22. The protrusions 22 may be disposed parallel, perpendicular or at various angles to each other, and may be used to produce a non-repeating debossed pattern. In certain embodiments, the protrusions 22 cover the surface 20, and are arranged on the external surface with varying depths, e.g., with the depths varying transversely from the center of the debossing drum 18 outward in a direction parallel with the rotational axis of the drum 18. The sheet material 16 may be fed or conveyed by drums or rollers serially arranged on a conveyor line or assembly in a linear direction indicated by arrow 38 in FIG. 2 so that the protrusions 22 on the external surface 20 continuously impinge or impress against the sheet material 16 creating corresponding scratches, striations, depressions or valleys 21 on the surface 14 of the sheet material 16.

As shown in FIGS. 1 and 2, the debossing step 24 may be accomplished with a debossing system 40 which may consist of a strip unwinder 42 adapted to support a coil 45 of sheet material 16 on a rotatable spool 44. The sheet material 16 unwinds from the spool 44 and is pulled through an entry straightener 46 which has a series of opposing rolls 48 which straighten the sheet material 16 as it is pulled through the straightener 46. The sheet material 16 then enters a debossing assembly 50 comprising the debossing drum 18, with its circumferential surface 20 having upraised or projecting protrusions, bumps or ridges 22, and opposing drum 52 having a smooth cylindrical external surface 54. The debossing drum 18 and opposing drum 52 may be un-driven, i.e., they are not driven by a motor and are freely rotatable.

The undebossed surface of the sheet material 16 enters the debossing assembly 50 and the debossed surface 17 of the sheet material 16 emerges from the debossing assembly 50 with depressions or valleys 21 having non-uniform depths which make up a debossed wood grain pattern 12. The sheet material 16 then enters an exit straightener 66 where it passes through opposed rolls 68 and is then rewound into coil form 72 by a strip rewinder 70 onto a take-up roller or spool 74. The strip rewinder 70 includes a driven take-up roller 74 that pulls the sheet material through the debossing assembly 50. The sheet material is straightened by pulling the sheet material past the un-driven debossing drum 18 and opposing drum 52 with the take-up roller 74.

FIGS. 3-6 illustrate details of the debossing unit 50. Hydraulic servo/pressure controllers 55A and 55B are located on either side of the debossing unit 50. The hydraulic servo/pressure controllers 55A and 55B are in fluid communication with hydraulic cylinders and pistons 56A and 56B, respectively. The hydraulic servo/pressure controller 55A communicates with the hydraulic cylinder and piston 56A via a hydraulic fluid inlet line 61A and a hydraulic fluid outlet line 63A. Similarly, the hydraulic servo/pressure controller 55B communicates with the hydraulic cylinder and piston 56B via hydraulic inlet line 61B and hydraulic outlet line 63B. The debossing unit 50 includes a frame 65 which supports the drums 18 and 52. The lower opposing drum 52 is rotatably mounted in a lower drum bearing support 67. The hydraulic cylinders and pistons 56A and 56B are supported by the frame 65 and contact a lower surface of the lower drum bearing support 67. The piston of each hydraulic cylinder and piston assembly 56A and 56B presses against the lower surface of the drum bearing support 67 to force the support and the opposing drum 52 upward toward the debossing drum 18. The hydraulic servo/pressure controllers 55A and 55B are used to supply pressurized hydraulic fluid to their respective hydraulic cylinders and pistons 56A and 56B in a controlled manner, as more fully described below.

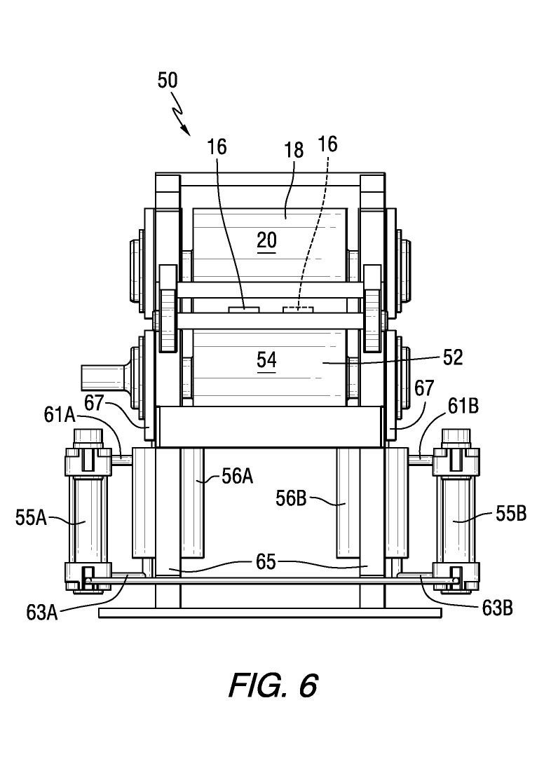

In accordance with embodiments of the present invention, the hydraulic servo/pressure controllers 55A and 55B and their hydraulic cylinders and pistons 56A and 56B are used to move the sheet material 16 transversely with respect to the debossing drum 18. Such transverse movement of the sheet material 16 is illustrated in FIGS. 5 and 6. The sheet material 16 (shown in solid lines) may initially be located at or near the center of the debossing drum 18. During the debossing process, the sheet material 16 may be moved transversely (as shown in phantom) toward a side of the debossing drum 18. Such transverse movement is performed gradually as the sheet material 16 is fed lengthwise through the debossing unit 50 in order to provide a continuous, non-repeating wood grain pattern on the sheet material 10.

The transverse movement of the sheet material 16 is accomplished by controlling the hydraulic pressure applied to each of the hydraulic cylinders and pistons 56A and 56B. The hydraulic servo/pressure controllers 55A and 55B are used to adjust the pressure of the hydraulic fluid supplied to their respective hydraulic cylinders and pistons 56A and 56B. When pressure is increased in one of the hydraulic servo/pressure controllers 55A or 55B, the piston of its respective hydraulic cylinder and piston 56A or 56B presses with more force against the lower drum bearing support 67. The resultant increased force pushes or pinches that side of the lower drum 52 toward the debossing drum 18, thereby causing the sheet material to move transversely away from that side of the lower drum 52. The hydraulic servo/pressure controllers 55A and 55B may thus be used to supply differential hydraulic pressures that cause the sheet material 16 to move transversely. If it is desired to maintain the sheet material 16 in a particular transverse position, the pressures supplied by the hydraulic servo/pressure controllers 55A and 55B may be equalized, thereby providing equal pressure on both transverse sides of the lower drum 52.

The particular pressures applied via the hydraulic servo/pressure controllers 55A and 55B may be routinely selected by those skilled in the art. For example, a standard pressure of 1,500 psi may be used, with pressure increases or decreases in a range of from 1 psi to 100 psi for each hydraulic servo/pressure controller, for example, pressure variations of from 2 psi to 10 psi may be suitable to control the transverse movement of the sheet material 16 across the debossing drum 18. A controller, such as a PLC, may be used to adjust the pressures to the hydraulic servo/pressure controllers 55A and 55B. A sensor (not shown), such as a light curtain, may be used to detect the transverse position of the sheet material. The detected position may then be fed to the controller to adjust the pressure applied to the hydraulic servo/pressure controllers 55A and 55B.

Although the hydraulic servo/pressure controllers 55A and 55B, and the hydraulic cylinders and pistons 56A and 56B, shown FIGS. 3-6 are configured to apply differential forces to the lower drum 52, other arrangements are possible. For example, hydraulic servo/pressure controllers may be engaged with the upper debossing drum 18 rather than the lower drum 52.

As shown in FIGS. 7 and 8, the surface 20 of the debossing drum 18 may comprise a depth-changing pattern in which the protrusions and/or valleys on the surface vary across the transverse length of the debossing drum 18. An example of such variation is illustrated in FIG. 8 in which the depths of the protrusions 22 in the central region of the drum are greater than the depths of the protrusions 22 in the regions toward the edges of the drum. As used herein, the terms “depth” and “depths” are used to refer to the distance a protrusion extends radially outward from the debossing drum 18, as well as the corresponding distance that a depression caused by a particular protrusion extends into the surface of the sheet material 16. In the embodiment shown, the central protrusions in the central region of the debossing drum 18 have depths of about 0.015 inch, gradually reducing to depths of about 0.006 inch in the regions at the outer edges of the debossing drum 18. The initial thickness of the sheet is about 0.042 inch. Such variation in protrusion depth generates varied wood grain depressions in the surface 17 of the sheet material 16. The protrusions may have a maximum depth in one of the regions, such as the central region in FIG. 8, that is at least 10 percent greater than a minimum depth in other regions, such as the edge regions in FIG. 8. For example, the maximum depth may be at least 50 percent or at least 100 percent greater than the minimum depth.

In accordance with embodiments of the invention, in subsequent coloring and staining operations, the applied stain fills the depressions or valleys and creates a darker appearance in the depressions or valleys that are deeper. For example, in the embodiment shown in FIG. 8, the larger-depth protrusions in the central region of the drum create deeper valleys and depressions in the corresponding portion of the sheet material 16, thereby creating a darker appearance of the depressions in the “cathedral” portion of the wood grain. Conversely, in the “ticking” portion of the wood grain at the edges of the debossing drum 18, the shallower depressions provide a lighter stained appearance. The overall effect provided by these depth variations in the cathedral and ticking portions of the wood grain is to provide a more realistic or natural wood grain appearance in the final stained product.

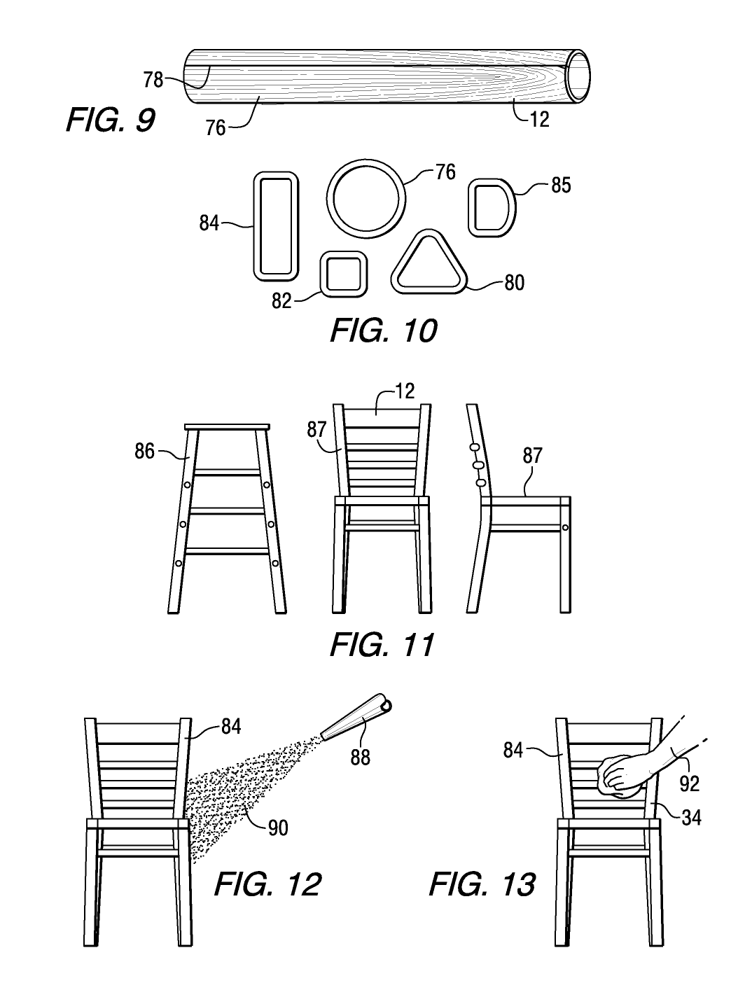

It should be noted, as illustrated in FIGS. 9 and 10, that if the debossed sheet material 16 is to be shaped into cylindrical or box tubes or tubular segments or lengths, several other processing steps may be undertaken after an alkaline solution and iron phosphate washing step 26. Thus, after the alkaline solution and iron phosphate washing step 26, a forming step 34 may be used to form the sheet material 16 into a cylindrical or box shape, with the next step being the product shaping step 36 for cutting and trimming the cylindrical or box tube, length or segment to the specific requirements for the desired end product, i.e., the park bench, restaurant seat, or item of metal furniture.

Steel coil 72 that has been patterned with depressions 21 on its first surface 14 may be rolled into round steel tube 76 and seam welded at 78, e.g., in a tube mill. Some of the steel tube 76 may be used in products in its round form, and the rest of the round tube may be reshaped by a commercially available Turix head reshaping tool or other means to produce other desired tube cross sections, including triangles 80, squares 82, rectangles 84, D-shapes, and any other desired shape in any desired size. The shapes, widths, and lengths are then assembled into the desired configurations such as a chair by cutting, welding, and brazing. Assembly can be facilitated with fixturing and cutouts. The article is now in its final configuration except for the coloring to provide the appearance of the desired species of wood.

In the alkaline solution and iron phosphate bath step, fabricated metal parts are first immersed in a liquid media with high alkalinity that caustically cleans the parts of grease, debris, and other substances that may hinder the quality of the powder coating process. After being rinsed in water, the cleaned surfaces of the fabricated parts then undergo an iron phosphate bath that deposits iron ions onto the fabricated part and creates an amorphous and inert surface ideal for resin powder coating. When finished, the fabricated parts are removed, rinsed, and are dried in a heated space to remove water therefrom.

When the alkaline solution and iron phosphate bath step 24 is complete, the next step is applying a base coat 28. The base color is selected to provide a desired wood appearance. The base color may be selected from the following group to provide the desired wood appearance: beige powder for natural wood appearance, tan powder for oak appearance, burgundy powder for mahogany appearance, medium brown powder for walnut appearance, and any multitudes of various formulations to produce any possible color combination.

A colored resin in powder form may be electrostatically applied to the fabricated parts. The parts are then cured at any suitable temperature, e.g., at a temperature of 380°, to bake the powder onto the fabricated surfaces. The electrostatic coating process applies a mild negative electrical ground charge to the fabricated parts to be finished. The electrostatic spray gun charges the powder finishing material with a positive electrical charge. The material is attracted like a magnet to the fabricated parts which assures a uniform coating application with little or no overspray or fog.

In certain embodiments, the colored resin powder is applied as a coating between 0.002 to 0.003 inches thick. In one embodiment, a thin mill powder may be used which can be applied in an extremely thin coating while still achieving complete uniform coverage. For example, the thin mill powder covers in a layer 0.001 to 0.005 inch thick. The importance of this thickness is that it assures that the debossed material will still have sufficient depth to accept the stain in a later step. This assures that the stain will not be removed from the debossed spaces during the wipe-off process discussed later. The base color of the thin mill powder determines the final color of the fabricated parts. For example, to simulate a natural wood finish use beige resin powder, to simulate an oak wood finish use tan resin powder, for a mahogany appearance use burgundy resin powder, and for a walnut appearance use medium brown resin powder. The color of the finish can be changed by merely changing the base color of the product.

The thin film powder coating formulations may include fillers known in the art. Any such fillers may be made to a smaller particle size to reduce any bumps or texture appearance. The final product may also be ground to a finer particle size. The powder coating may typically be ground to a mean of 40 to 60 microns, and the thin film powders may typically be ground to a mean of 25 to 30 microns.

Electrostatic application of the powder provides for the desired wood grain color in the specific color chosen and gives the sheet material 16 a protective layer for end products such as park benches or restaurant seats. A baking step 32 bakes the electrostatically applied powder onto the first surface 14 of the sheet material 16, e.g., at a temperature of 400° for at least 20 minutes. Filler material ground to size may be used to reduce the volume of resin used in the coating.

The color for the stain in the debossed areas is selected to provide a desired wood appearance. The stain may be selected from the following group to provide the desired contrast in colors: cherry stain for natural wood appearance or for oak appearance, black stain for mahogany appearance or walnut appearance, and any other multitude of various stain applications to produce any possible color combination.

The staining step 31 may be accomplished as follows. First, an oil based stain may be applied to the fabricated part. The stain is then wiped completely off of the fabricated part before drying. The stain that remains in the debossed areas creates the varied wood grain appearance. This appearance is created without the necessity or use of any artistic ability on the part of the workman required to complete this process. A clear coat 33 of protective material such as polyurethane may be applied over the stain coat.

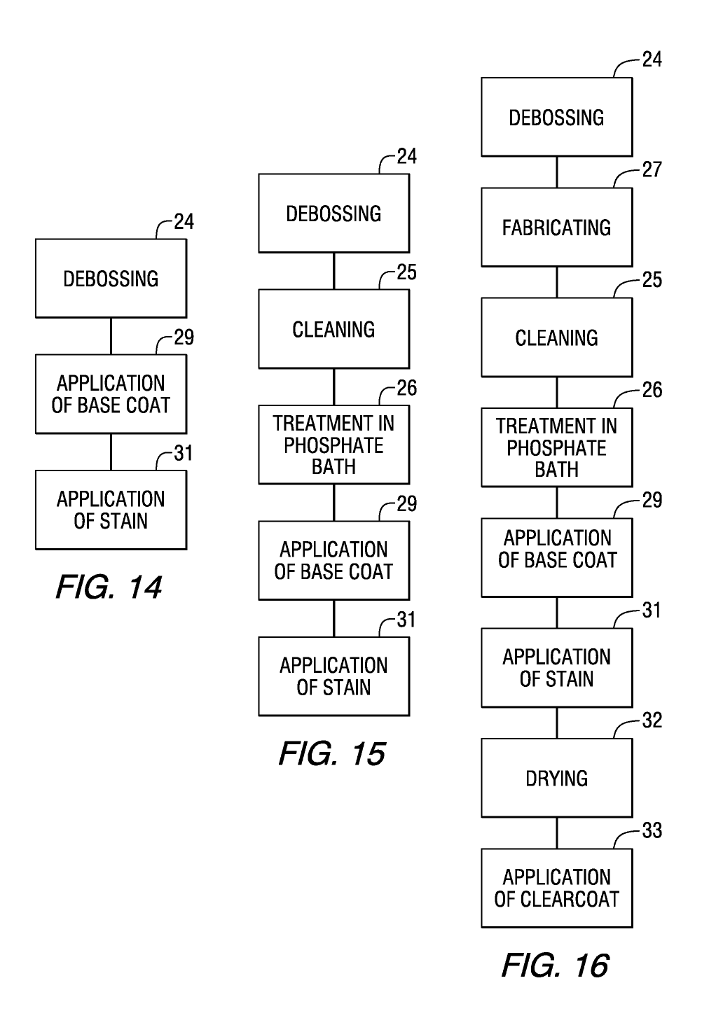

As shown in FIG. 14, a process for creating a non-repeating, depth-changing pattern that imitates a wood grain appearance on metal material may be provided by first in impressing step 24 an array of depressions is impressed into the metal material. Next in applying step 29, a colored resin base coat is applied to the metal material by completely covering the metal material but thinly enough so that it does not completely fill the depressions in the surface of the material. Lastly, in applying step 31, stain is applied to fill the depressions in the metal material so that the stain color provides a contrast with the base color of the resin coat to provide a wood grain appearance on the metal material.

As shown in FIG. 15, a process for creating a non-repeating, depth-changing pattern that imitates a wood grain appearance on sheet metal may be produced by a debossing step 24, followed by a cleaning step 25, e.g., in an alkaline bath. Next, in an iron phosphate bath treatment step 26, the cleaned and rinsed part is immersed in an iron phosphate solution, and dried. Next, a base coat application step 29 is performed, e.g., a base coat of a colored resin powder is electrostatically applied to the sheet material. Next, a stain application step 31 is performed in which a contrasting color stain is applied to the depressions of the sheet material which provides a darker color variation to the lighter base coat, thereby creating a random wood grain appearance on the sheet material.

As shown in FIG. 16, a process for creating a non-repeating, depth-changing pattern on a sheet material that imitates a wood grain appearance is accomplished by a debossing step 24, followed by a fabricating step 27 in which the end product is formed from the debossed sheet material, e.g., by forming cylindrical or boxed tubular shapes, cutting them to lengths, and assembling the cylindrical or boxed tubular shapes into the desired end product. Next, an alkaline bath step 25 and an iron phosphate bath step 26 are conducted. Next, a base coat application step 29 is performed in which a base coat of a colored resin powder is electrostatically applied to the sheet material. Next, a stain application step 31 is performed in which a contrasting color stain is applied to the depressions of the sheet material which provides a darker color variation to the lighter base coat and thereby creating a random wood grain appearance on the sheet material. Next, a drying step 32 is performed to dry the stain, and finally a clear-coat application step 33 is performed in which a clear protective coating material such as polyurethane, polyethylene or the like is applied to the entire end product.

The present invention provides wood grain appearances on the external surface or surfaces of objects, items, furniture, fixtures, and equipment. The process and apparatus may be used to create a random or non-repeating, depth-changing pattern on the external surface or surfaces of strip material such as steel and metal sheet for simulating a wood grain appearance thereon. The steel and metal sheet can be used for a variety of applications such as metal furniture, restaurant furniture, park furniture, playground equipment, and also for any round or box-shaped tubular segments or lengths that can be formed into anything from handrails and fences to poles and stationary bicycles racks. Other applications may include indoor tables, household fixtures such as outlet covers, baseboard trim, or anywhere else wood is applied. In order to provide a more appealing and aesthetic appearance for blending and corresponding the item or product with its surroundings such as an outdoor park, western-themed restaurant, or assisted living facility, it is desirable to coat, cover, laminate or form on the steel or metal surface a simulated wood grain appearance.

Whereas particular embodiments of this invention have been described above for purposes of illustration, it will be evident to those skilled in the art that numerous variations of the details of the present invention may be made without departing from the invention as defined in the appended claims.

What is claimed is:

1. An apparatus for making a wood grain appearance on sheet material comprising a debossing assembly for imparting a non-repeating wood grain pattern on the sheet material, wherein the debossing assembly comprises a debossing drum and an opposing drum, and at least one of the debossing drum and opposing drum are supported by at least one height-adjustable piston that moves the debossing and opposing drums toward or away from each other to a position in which opposing surfaces of the debossing and opposing drum are unequally spaced from each other on one longitudinal end of the debossing and opposing drums in comparison with another longitudinal end of the debossing and opposing drums.

2. The apparatus of claim 1, wherein the debossing assembly comprises two of the height-adjustable pistons, one of the height-adjustable pistons is located adjacent to the one longitudinal end of the debossing and opposing drums, and the other of the height-adjustable pistons is located adjacent to the other longitudinal end of the debossing and opposing drums.

3. The apparatus of claim 2, wherein the opposing drum is positioned below the debossing drum, and the height-adjustable pistons press against drum bearing supports located adjacent to the longitudinal ends of the opposing drum.

4. The apparatus of claim 1, wherein the debossing and opposing drums are non-driven.

5. The apparatus of claim 1, further comprising a driven take-up roller structured and arranged to pull the sheet material through the debossing and opposing drums.

6. The apparatus of claim 1, wherein the debossing drum comprises protrusions extending from a generally cylindrical surface of the debossing drum, and the protrusions have different depths in different regions along the transverse length of the debossing drum.

7. An apparatus for making a wood grain appearance on sheet material comprising a debossing drum for imparting a depth-changing wood grain pattern on the sheet material, wherein the debossing drum comprises protrusions extending from a generally cylindrical surface of the debossing drum, and the protrusions have different depths in different regions along the transverse length of the debossing drum.

8. The apparatus of claim 7, wherein the protrusions have a maximum depth in one of the regions and a minimum depth in another one of the regions, and the maximum depth is at least 10 percent greater than the minimum depth.

9. The apparatus of claim 8, wherein the maximum depth is at least 50 percent greater than the minimum depth.

10. The apparatus of claim 8, wherein the maximum depth is at least 100 percent greater than the minimum depth.

11. The apparatus of claim 8, wherein the protrusions having the maximum depth form a cathedral wood pattern, and the protrusions having the minimum depth form a ticking wood pattern.

12. A method of making a wood grain appearance on sheet material comprising feeding the sheet material through a debossing assembly to thereby impart a non-repeating wood grain pattern on the sheet material, wherein the debossing assembly moves the sheet material in a transverse direction as the sheet material is fed through the debossing assembly.

13. The method of claim 12, wherein the position of the sheet material is moved transversely to the feed direction of the sheet material by applying unequal pressure to an edge of the sheet material.

14. The method of claim 12, wherein the sheet material is fed through the debossing assembly by pulling the sheet material.

15. The method of claim 14, wherein the debossing assembly comprises a non-driven debossing drum and non-driven opposing drum.

16. A method of making a wood grain appearance on sheet material comprising contacting the sheet material with a debossing drum to thereby impart a depth-changing wood grain pattern on the sheet material, wherein the debossing drum comprises protrusions extending from a generally cylindrical surface of the debossing drum, and the protrusions have different depths in different regions along the transverse length of the debossing drum.

17. A debossed sheet material comprising a non-repeating and depth-changing wood grain pattern.

18. The debossed sheet material of claim 17, wherein the depth-changing wood grain pattern comprises a maximum depth in one region along a transverse direction of the sheet material, and a minimum depth in another region along the transverse direction of the sheet material.

19. The debossed sheet material of claim 18, wherein the maximum depth is at least 50 percent greater than the minimum depth.

20. The debossed sheet material of claim 18, wherein the maximum depth is at least 100 percent greater than the minimum depth.
